(19) United States
(12) Patent Application Publication
(10) Pub. No.: US 2009/0164617 A1
(43) Pub. Date: Jun. 25, 2009

(54) NETWORK APPARATUS HAVING A DATABASE, MANAGEMENT METHOD AND TANGIBLE MACHINE-READABLE MEDIUM FOR MANAGING INTERNET PROTOCOL CONNECTION RULES OF THE DATABASE

(75) Inventors: Cheng-Kai Chen, Hsi-Chi City (TW); Hung Min Sun, Hsinchu City (TW); Shih-Ying Chang, Nantou City (TW); Yao-Hsin Chen, Shalu Township (TW); Bing-Zhe He, Yonghe City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 12/052,499

(22) Filed: Mar. 20, 2008

(30) Foreign Application Priority Data
Dec. 25, 2007 (TW) 096149912

(51) Int. Cl. G06F 15/16

(52) U.S. Cl. 709/223

(57) ABSTRACT

A network apparatus having a database, a management method and a tangible machine-readable medium for managing internet protocol (IP) connection rules of the database are provided. The database stores at least one first IP connection rule. The management method comprises the following steps: writing a second IP connection rule through one of a plurality of management programs; determining there is a conflict between the at least one first IP connection rule and the second IP connection rule, and eliminating the conflict according to a weight value of the at least one first IP connection rule and a weight value of the second IP connection rule. The at least one first IP connection rule and the second IP connection rule are used in one network connection.

This application claims the benefit of priority based on Taiwan Patent Application No. 096149912 filed on Dec. 25, 2007, of which the contents are incorporated herein by reference in its entirety.

### CROSS-REFERENCES TO RELATED APPLICATIONS

Not applicable.

### BACKGROUND OF THE INVENTION

1. Field of the Invention

The present invention relates to a network apparatus having a database, a management method and a tangible machine-readable medium for managing internet protocol (IP) connection rules of the database; more specifically, relates to a network apparatus, a management method, and a tangible machine-readable medium for avoiding conflicts between IP connection rules.

2. Descriptions of the Related Art

In recent years, with widespread use of the Internet, network security has come up as an increasingly important issue, and accordingly, pertinent solutions have become a hot topic of great concern. Internet protocol security (IPSec) is just among one of the security specifications proposed for IP.

The IPsec mainly serves dual functions: an authentication function and an encryption function. The authentication function means that when a connection is made to the Internet, identities of both parties involved in a communication session are authenticated to protect the transmission data from damage or tampering by a third party The encryption function means that data transmission between both parties is encrypted to prevent a third party from intercepting the data and having a direct access to content thereof. A core component of the IPsec is an encryption algorithm. Once a user establishes a network connection with a server, both parties will initially have to determine an IP connection rule for encryption and decryption, for example, to adopt an advanced encryption standard (AES) algorithm or a data encryption standard (DES) algorithm for encryption of data. The IP connection rule agreed by both parties is stored into a database of the user and a database of the server individually; in other words, the agreed encryption algorithm is stored in a security association database (SADB) and a security policy database (SPDB). Then, when data transmission between the user and the server is desired, the transmitter may use the agreed IP connection rule to encrypt data to be transmitted, while the receiver may use corresponding IP connection rule for decryption to obtain the data.

In conventional methods, there exists only one management program in a single system for managing the IPsec, e.g., a management program known as the Internet Key Exchange (IKE), so the management program has direct access to the database. However, recently, a new management program for managing the IPsec, which is known as the Internet Key Exchange version 2 (IKEv2), has also been proposed. Under this circumstance, if two different management programs both have a direct access to the database coexist in the single system, it will effect on access to IP connection rules.

Specifically, as shown in FIG. 1, a network apparatus 1 comprises a first management unit 101, a second management unit 103, and a database 105. The first management unit 101 employs an IKE management program to access IP connection rules in the database 105, while the second management unit 103 employs an IKEv2 management program to access IP connection rules in the database 105. Here, the database 105 is the SADB or the SPDB described above. Assuming that a user writes an IP connection rule into the database 105 for a specific network connection (e.g., adopting the AES encryption algorithm for a network connection with a site 140.92.61.197) at first through the IKE management program residing in the first management unit 101. Then, when the user desires to write another network connection rule for the same network connection (e.g., adopting the DES encryption algorithm for a network connection with the site 140.92.61.197) through the IKEv2 management program residing in the second management unit 103 in to the same database 105, the network apparatus 1 will be confused which IP connection rule to use for data transmission of this network connection (site 140.92.61.197), or use a wrong IP connection rule for data encryption, resulting in loss of data during transmission or failure of the receiver to decrypt the data properly.

Accordingly, it is becoming increasingly important to avoid corruption or loss of data as management programs of different IPsecs write different IP connection rules on the same network connection. In view of this, efforts still have to be made in the network communication industry to provide a solution to manage IP connection rules effectively.

### SUMMARY OF THE INVENTION

One objective of this invention is to provide a management method for managing IP connection rules of a database, wherein the database is used to store at least one first IP connection rule. The management method comprises the steps of: writing a second IP connection rule through one of a plurality of management programs; determining that a conflict is occurred between the at least one first IP connection rule and the second IP connection rule; and eliminating the conflict according to a first weight value of the at lest one first IP connection rule and a second weight value of the second IP connection rule. The at least one first IP connection rule and the second IP connection rule are used in the same network connection.

Another objective of this invention is to provide a network apparatus having a database, wherein the database is used to store at least one first IP connection rule. The network apparatus comprises a plurality of management units, a conflict determining unit, and a conflict eliminating unit. The conflict determining unit is used to determine that a conflict is occurred between the at least one first IP connection rule and a second IP connection rule when one of the management units writes the second IP connection rule. The conflict eliminating unit is used to eliminate the conflict according to a first weight value of the at least one first IP connection rule and a second weight value of the second IP connection rule. The at least one first IP connection rule and the second connection rule are used in the same network connection.

Yet a further objective of this invention is to provide a tangible machine-readable medium having executable code to cause a network apparatus to perform a management method for managing IP connection rules of a database, wherein the database is used to store at least one first IP connection rule. The management method comprises the steps of: writing a second IP connection rule through one of a plurality of management programs; determining that a conflict is occurred between the at least one first IP connection rule and the second IP connection rule; and eliminating the conflict according to a first weight value of the at lest one first IP connection rule and a second weight value of the second IP connection rule. The at least one first IP connection rule and the second IP connection rule are used in the same network connection.

In summary, the present invention determines whether a conflict occurs due to application of different IP connection rules to a same network connection, and selectively eliminates one of the IP connection rules causing the conflict according to weight values thereof. As a result, potential conflicts between different IP connection rules incurred by more than one IPsec management programs in a single system can be avoided, thereby to maintain quality of the network connection and speed of data transmission.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating a conventional network apparatus;

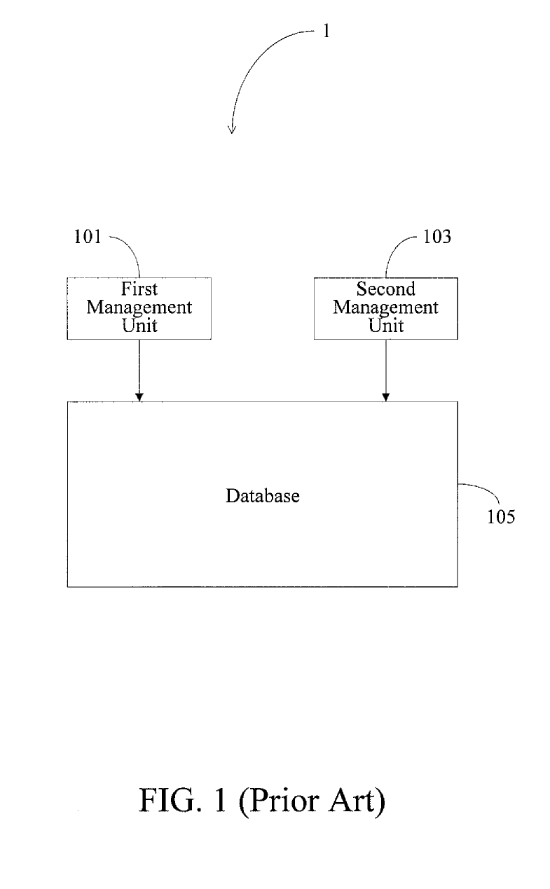

FIG. 2 is a schematic diagram illustrating a first embodiment of the present invention; and

FIG. 3 is a flow chart illustrating a second embodiment of the present invention.

### DESCRIPTION OF THE PREFERRED EMBODIMENT

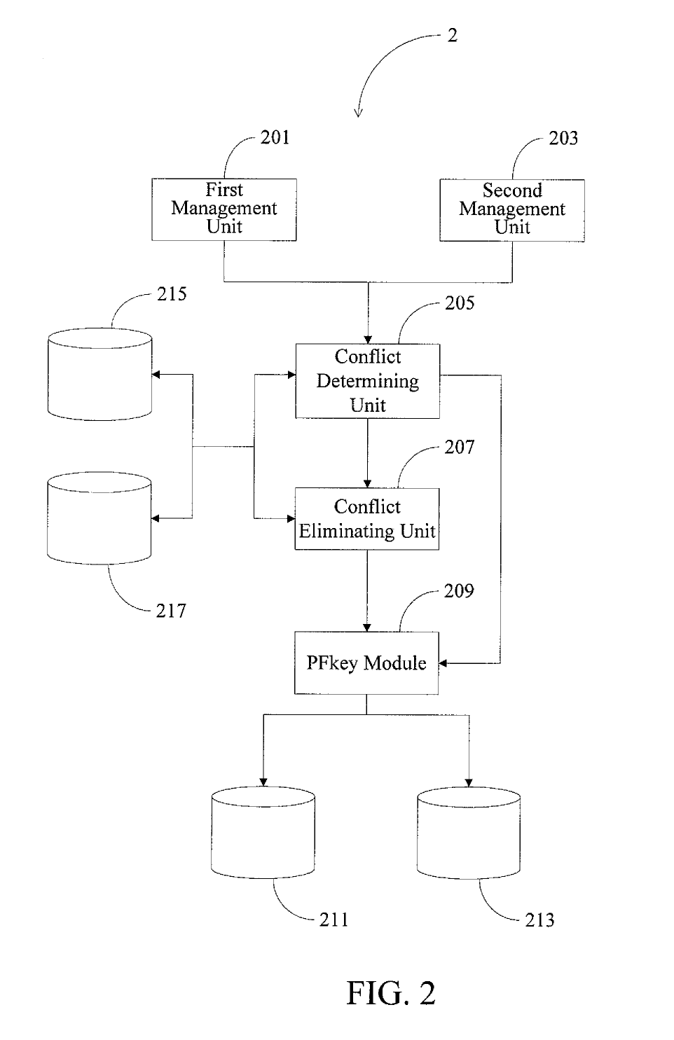

As shown in FIG. 2, a first embodiment of the present invention is a network apparatus 2, which comprises a plurality of management units 201, 203, a conflict determining unit 205, a conflict eliminating unit 207, a program function key (PFkey) module 209, a security association database (SADB) 211, a security policy database (SPDB) 213, an application security association database (ASADB) 215, and an application security policy database (ASPDB) 217. For simplicity, only two management units, i.e., a first management unit 201 and a second management unit 203, are shown in FIG. 2. The first management unit 201 may use an IKE management program to access IP connection rules in the SADB 211 and the SPDB 213 through the PFkey module 209. Likewise, the second management unit 203 may use an IKEv2 management program to access IP connection rules in the SADB 211 and the SPDB 213 through the PFkey module 209. The ASADB 215 and the ASPDB 217 are used to record all IP connection rules written into the SADB 211 and the SPDB 213 by the first management unit 201 and the second management unit 203, for example, which IP connection rule applies on the network connection or a time that an IP connection rule is used.

Hereinafter, description will be made on how the network apparatus 2 manages IP connection rules of the SADB 211 and the SPDB 213. Initially, it is assumed that the first management unit 201 is ready to write a first IP connection rule (e.g., adopting an AES encryption algorithm for a network connection that is connected with the site 140.92.61.197 and port 23) to the SADB 211 and the SPDB 213. Then the conflict determining unit 205 retrieves all IP connection rules recorded in the ASADB 215 and the ASPDB 217, and detects a conflict by determining whether the first IP connection rule and the recorded IP connection rules are applied to the same network connection but adopt different encryption algorithm. If there exists no conflict between the first IP connection rule and the recorded IP connection rules, the conflict determining unit 205 writes the first IP connection rule into the SADB 211 and the SPDB 213 through the PFkey module 209, and at the same time writes the first IP connection rule into the ASADB 215 and the ASPDB 217.

If subsequently the second management unit 203 attempts to write a second IP connection rule (e.g., adopting a DES encryption algorithm for a network connection that is connected with the site 140.92.61.197 and port 23) into the SADB 211 and the SPDB 213, then as previously described, the conflict determining unit 205 retrieves all IP connection rules recorded in the ASADB 215 and the ASPDB 217. At this point, the ASADB 215 and the ASPDB 217 have 25 already stored the first IP connection rule therein. Then, the conflict determining unit 205 detects a conflict by determining whether the second IP connection rule and the recorded IP connection rules are applied to the same network connection but adopt different encryption algorithm.

In this embodiment, the second IP connection rule (adopting a DES encryption algorithm for a network connection that is connected with the site 140.92.61.197 and port 23) and the previously recorded first IP connection rule (adopting an AES encryption algorithm for the network connection that is connected with the site 140.92.61.197 and port 23) are both applied to the same network connection (connected with the site 140.92.61.197 and port 23), but adopt different encryption algorithms (the DES and the AES encryption algorithms respectively). Therefore, if the second IP connection rule is also written into the SADB 211 and the SPDB 213 through the PFkey module 209, a conflict will occur between the first IP connection rule and the second connection rule.

Once the conflict determining unit 205 determines that a conflict would occur between the first IP connection rule and the second connection rule, the conflict eliminating unit 207 will assign weight values to the first IP connection rule and the second IP connection rule respectively according to a using time and a status thereof, for example, whether it is in use at present. The way to assign weight values will readily occur to those skilled in the art can understand the current IP connection rule architecture, and thus no necessary detail is given.

If the weight value of the first IP connection rule is assigned to be higher than that of the second IP connection rule, which means that the second IP connection rule is less important than the first IP connection rule, the conflict eliminating unit 207 will simply refuse to write the second IP connection rule into the SADB 211 and the SPDB 213, or write the second IP connection rule into the SADB 211 and the SPDB 213 through the PFkey module 209 but cease it.

On the other hand, if the weight value of the first IP connection rule is assigned to be lower than that of the second IP connection rule, which means that the first IP connection rule is less important than the second IP connection rule, the conflict eliminating unit 207 will delete the first IP connection rule stored in the SADB 211 and the SPDB 213 through the PFkey module 209, or cease the first IP connection rule stored in the SADB 211 and the SPDB 213 through the PFkey module 209. Likewise, the conflict eliminating unit 207 will delete or cease the first IP connection rule stored in the ASADB 211 and the ASPDB 213.

The above description on how to avoid or eliminate a conflict between IP connection rules are intended only to illustrate rather than to limit the present invention. The way to delete or cease an IP connection rule will readily occur to those skilled in the art can understand the current IP connection rule architecture, and thus no necessary detail is given.

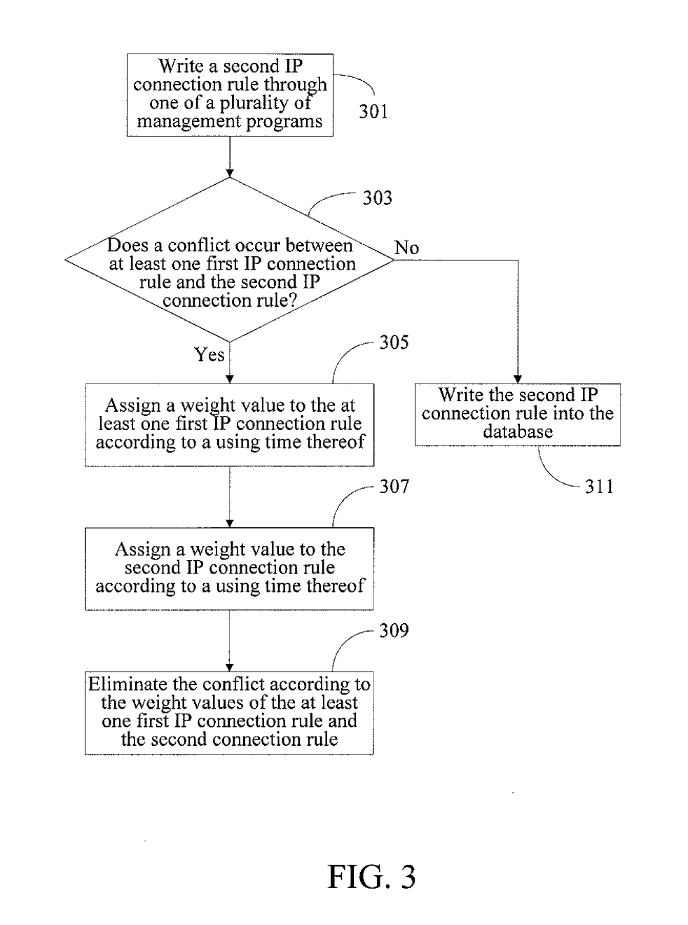

A second embodiment of the present invention is a management method for managing IP connection rules of a database, which is a method applied to the network apparatus 2 described in the first embodiment. More specifically, the method of the second embodiment which is illustrated in FIG. 3 can be implemented by an application program controlling various units and modules of the network apparatus 2. This application program may be stored in a tangible machine-readable medium, such as a read only memory (ROM), a flash memory, a floppy disk, a hard disk, a compact disk, a mobile disk, a magnetic tape, a database accessible to networks, or any other storage media with the same function and well known to those skilled in the art.

The following steps will be described to explain the management method for managing IP connection rules of the database. The database includes an SADB and an SPDB, and has already stored at least one first IP connection rule therein. Initially in step 301, a second IP connection rule is written through one of a plurality of management programs. Then in step 303, a conflict determining unit determines whether a conflict occurs between the at least one first IP connection rule and the second IP connection rule. If yes, step 305 is executed, in which a conflict eliminating unit assigns a weight value to the at least one first IP connection rule according to a using time thereof. Next in step 307, a conflict eliminating unit assigns a weight value to the second IP connection rule according to a using time thereof. And in step 309, the conflict is eliminated according to the weight values of the at least one first IP connection rule and the second IP connection rule.

On the other hand, if there is no conflict occurs between the at least one first IP connection rule and the second IP connection rule in step 303, the second IP connection rule is written into the database in step 311.

In addition to the steps revealed in FIG. 3, the second embodiment can also execute all the operations of the first embodiment, in which those skilled in the art can understand the corresponding steps and operations of the second embodiment by the explanation of the first embodiment, and thus no necessary detail is given.

It follows from the above description that, this invention determines whether a conflict occurs due to application of different IP connection rules to the same network connection, and selectively eliminates one of the IP connection rules causing the conflict according to weight values thereof. This may keep compatibility among contents of the database and enable the network connection to operate properly. As a result, potential conflicts between different IP connection rules incurred by more than one IPsec management programs in a single system can be avoided, thereby to maintain quality of the network connection and speed of data transmission.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A management method for managing internet protocol (IP) connection rules of a database, the database storing at least one first IP connection rule, the management method comprising the steps of:
writing a second IP connection rule through one of a plurality of management programs;
determining that a conflict is occurred between the at least one first IP connection rule and the second IP connection rule; and
eliminating the conflict according to a first weight value of the at lest one first IP connection rule and a second weight value of the second IP connection rule;
wherein the at least one first IP connection rule and the second IP connection rule are used in one network connection.

2. The management method of claim 1, wherein the network connection is defined by an IP address and a port.

3. The management method of claim 1, wherein the eliminating step further comprises the steps of:
assigning the first weight value of the at least one first IP connection rule according to a using time of the same; and
assigning the second weight value of the second IP connection rule according to a using time of the same.

4. The management method of claim 1, wherein the eliminating step further comprises the step of:
deleting one of the at least one first IP connection rule and the second IP connection rule.

5. The management method of claim 1, wherein the eliminating step further comprises the step of:
ceasing one of the at least one first IP connection rule and the second IP connection rule.

6. The management method of claim 1, wherein the database is one of a security association database (SADB) and a security policy database (SPDB).

7. A network apparatus having a database, the database storing at least one first IP connection rule, the network apparatus comprising:
a plurality of management units;
a conflict determining unit; and
a conflict eliminating unit;
wherein the conflict determining unit determines that a conflict is occurred between the at least one first IP connection rule and the second IP connection rule when one of the management units writes a second IP connection rule, the conflict eliminating unit eliminates the conflict according to a first weight value of the at least one first IP connection rule and a second weight value of the second IP connection rule, the at least one first IP connection rule and the second connection rule are used in one network connection.

8. The network apparatus of claim 7, wherein the network connection is defined by an IP address and a port.

9. The network apparatus of claim 7, wherein the first weight value of the at least one first IP connection rule is assigned according to a using time of the same, and the second weight value of the second IP connection rule is assigned according to a using time of the same.

10. The network apparatus of claim 7, wherein the conflict eliminating unit deletes one of the at least one first IP connection rule and the second IP connection rule for eliminating the conflict.

11. The network apparatus of claim 7, wherein the conflict eliminating unit ceases one of the at least one first IP connection rule and the second IP connection rule for eliminating the conflict.

12. The network apparatus of claim 7, wherein the database is one of a SADB and a SPDB.

13. A tangible machine-readable medium having executable code to cause a network apparatus to perform a management method for managing IP connection rules of a database, the database storing at least one first IP connection rule, the management method comprising the steps of:
writing a second IP connection rule through one of a plurality of management programs;
determining that a conflict is occurred between the at least one first IP connection rule and the second IP connection rule; and
eliminating the conflict according to a first weight value of the at lest one first IP connection rule and a second weight value of the second IP connection rule;
wherein the at least one first IP connection rule and the second IP connection rule are used in one network connection.

14. The tangible machine-readable medium of claim 13, wherein the network connection is defined by an IP address and a port.

15. The tangible machine-readable medium of claim 13, wherein the eliminating step further comprises the steps of:
assigning the first weight value of the at least one first IP connection rule according to a using time of the same; and
assigning the second weight value of the second IP connection rule according to a using time of the same.

16. The tangible machine-readable medium of claim 13, wherein the eliminating step further comprises the step of:
deleting one of the at least one first IP connection rule and the second IP connection rule.

17. The tangible machine-readable medium of claim 13, wherein the eliminating step further comprises the step of:
ceasing one of the at least one first IP connection rule and the second IP connection rule.

18. The tangible machine-readable medium of claim 13, wherein the database is one of a SADB and a SPDB.
